(19) United States
(12) Patent Application Publication
(10) Pub. No.: US 2009/0039997 A1
(43) Pub. Date: Feb. 12, 2009

(54) Metal Terminal, Coil Component, and Method for Holding and Fixing Conductive Wire

(75) Inventors: Hideoki Nakashima, Tokyo (JP); Koji Niino, Tokyo (JP); Kenji Takano, Tokyo (JP); Norio Yokoyama, Tokyo (JP)

Correspondence Address: Stevens Law Group, 1754 Technology Drive, Suite #226, San Jose, CA, 95110, US

(73) Assignee: Sumida Corporation, Chuo-ku (JP)

(21) Appl. No.: 12/282,639

(22) PCT Filed: Feb. 22, 2007
(86) PCT No.: PCT/JP2007/053315

§ 371 Date: Sep. 11, 2008

(30) Foreign Application Priority Data
Mar. 13, 2006 (JP) 2006-067798

(51) Int. Cl. H01F 27/29; H01R 4/10; H01R 4/18

(52) U.S. Cl. 336/192; 439/877; 439/878

(57) ABSTRACT

The present invention provides a metal terminal that can hold and fix a conductive wire thereto without excessive deformation. In the metal terminal of this invention, a predetermined relationship is set between a length in the lengthwise direction and a width in the widthwise direction of a conductive wire winding portion and a diameter of the conductive wire wound around the conductive wire winding portion to reduce force applied to the conductive wire when holding and fixing the conductive wire.

### TECHNICAL FIELD

The invention relates to a metal terminal for use in a coil component and the like, and specifically, to a metal terminal having an opening portion for holding and fixing a conductive wire. The invention also relates to a coil component having the metal terminal, and to a method for holding and fixing a conductive wire to the metal terminal.

### BACKGROUND ART

Conventionally, as a known method for holding and fixing a conductive wire to a metal terminal having an opening portion, it is known to form a slit extending parallel to a metal terminal 101 as illustrated in FIG. 10A or forming a slit broadening with a predetermined angle as illustrated in FIG. 10B, intertwine a conductive wire 106 with the slit of the metal terminal 101, and then compression process the opening portion 102 of the metal terminal 101 with a compression tool 120 as illustrated in FIG. 10C, so that the conductive wire 106 is held and fixed to the metal terminal 101 (see Patent Document 1).

As illustrated in FIG. 10D, an end portion of the conductive wire 106 sandwiched in the slit of the metal terminal 101 is compressed to form an oblong oval shape in the cross section thereof, and hence the conductive wire 106 and the metal terminal 101 are mechanically firmly connected with excellent conductivity.

Patent Document 1: DE3404008

### DISCLOSURE OF THE INVENTION

In the metal terminal described in Patent Document 1, when compression processed, the conductive wire is deformed to have an oblong oval in the cross section, so that when the conductive wire has been excessively flattened, bending strength of the conductive wire may decrease to cause wire disconnection at the boundary between the deformed portion and the undeformed portion.

Further, as heating resistance of the conductive wire decreases with an increase in the degree of flatness thereof, the conductive wire may be blown out due to heat applied thereto in the step of welding the conductive wire and the metal terminal which is performed after compression processing the conductive wire.

Specifically, when the conductive wire is wound a plurality of times around the metal terminal to be held on and fixed to the metal terminal, if the conductive wire is loosely wound, positions of the conductive wire around the metal terminal are unstable when compression processing, so that the position of the conductive wire held and fixed to the metal terminal will vary. Thus, there is a problem that conductivity of heat applied when welding the conductive wire and metal terminal is not uniform among the metal terminals, so that poor welding occurs, and the quality of the metal terminals after welding varies.

The invention has been made in view of the above-descried problems and intends to provide a metal terminal capable of holding and fixing a conductive wire thereto without excessively deforming the conductive wire, and a coil component utilizing the metal terminal. This invention also intends to provide a method for holding and fixing a conductive wire to a metal terminal capable of holding and fixing a conductive wire thereto without excessive deformation.

A metal terminal according to the invention includes an opening portion having a conductive wire winding portion and a conductive wire introducing portion, characterized in that when “a” is defined as a length in the lengthwise direction of the conductive wire winding portion, “b” is defined as a width in the widthwise direction of the conductive wire winding portion, and “c” is defined as a diameter of the conductive wire to be wound around the metal terminal, 3c≦a≦5c and c<b<2c are satisfied.

In the metal terminal according to the invention, since a prescribed relationship is set between the lengths in the lengthwise direction and in the widthwise direction of the conductive wire winding portion and the diameter of the conductive wire to be wound around the conductive wire winding portion, the force applied to the conductive wire when holding and fixing the conductive wire to the conductive wire winding portion by deforming the opening portion of the metal terminal can be reduced.

The metal terminal according to the invention is capable of holding and fixing a conductive wire thereto without causing excessive deformation in the conductive wire.

A coil component according to the invention includes a bobbin, a conductive wire wound around the bobbin, and a metal terminal to which an end portion of the conductive wire is held and fixed. The metal terminal includes an opening portion having a conductive wire winding portion and a conductive wire introducing portion, characterized in that when “a” is defined as a length in the lengthwise direction of the conductive wire winding portion, “b” is a width in the widthwise direction of the conductive wire winding portion, and “c” is a diameter of the conductive wire wound around the metal terminal, 3c≦a≦5c and c<b<2c are satisfied.

In the coil component according to the invention, since a prescribed relationship is set for the lengths in the lengthwise direction and in the widthwise direction of the conductive wire winding portion and the diameter of the conductive wire to be wound around the conductive wire winding portion, the force applied to the conductive wire winding portion, when holding and fixing the conductive wire by deforming the opening portion of the metal terminal can be reduced.

In the coil component according to the invention, a conductive wire is held and fixed to a metal terminal without causing excessive deformation in the conductive wire, the quality of the coil component can be made uniform.

A method for holding and fixing an end portion of a conductive wire to a metal terminal including an opening portion having a conductive wire winding portion and a conductive wire introducing portion according to the invention, which includes the steps of: winding an end portion of the conductive wire a plurality of times around the conductive wire winding portion; bringing a compression tool into contact with the metal terminal and compressing the metal terminal with the compressing tool until the opening portion of the conductive wire winding portion is closed; and bringing the welding electrode into contact with the metal terminal and welding the metal terminal and conductive wire with the welding electrode.

Since the method for holding and fixing the conductive wire to the metal terminal according to the invention includes the steps of: winding an end portion of the conductive wire a plurality of times around the conductive wire winding portion; bringing a compression tool into contact with the metal terminal and compressing the metal terminal with the compressing tool until the opening portion of the conductive wire winding portion is closed; and bringing the welding electrode into contact with the metal terminal and welding the metal terminal and conductive wire with the welding electrode, the force applied to the conductive wire when holding and fixing the conductive wire to the conductive wire winding portion of the metal terminal can be reduced.

The method for holding and fixing a conductive wire to a metal terminal according to the invention is capable of holding and fixing the conductive wire to the metal terminal thereto without causing excessive deformation in the conductive wire.

### BRIEF DESCRIPTION OF DRAWINGS

FIG. 1 is an overall configuration diagram of a metal terminal according to an embodiment of the invention.

FIG. 2A is an overall view when metal terminal components each having the metal terminal have been mounted on a frame. FIG. 2B is an overall view when the metal terminal components each having the metal terminal have been mounted on a base resin.

FIG. 3 is an overall view of a coil component including the metal terminal component having the metal terminal.

FIG. 4 is a flow-chart illustrating a manufacturing step in which the conductive wire is held and fixed to the metal terminal.

FIGS. 5A, 5B, 5C, 5D are views each illustrating changing states of the metal terminal and the conductive wire according to the flow-chart of the manufacturing step.

FIGS. 6A, 6B are views illustrating that a relationship between the width “b” in the widthwise direction of the conductive wire winding portion of the metal terminal and the diameter “c” of the conductive wire is set as b <2c.

FIG. 7 is a view illustrating a definition of a long/short axis aspect ratio.

FIGS. 8A to 8C are views for illustrating a state of the conductive wire wound around the metal terminal deforms in compression processing.

FIG. 9 is a view comparing the states of the conductive wire in the conductive wire winding portion after compression processing.

FIGS. 10A to 10D are configuration views of a metal terminal of related art which holds and fixes a conductive wire by winding the conductive wire around.

### BEST MODE FOR CARRYING OUT THE INVENTION

The best modes for carrying out a metal terminal of the invention are described with reference to accompanying drawings; however, the invention is not limited to the modes below.

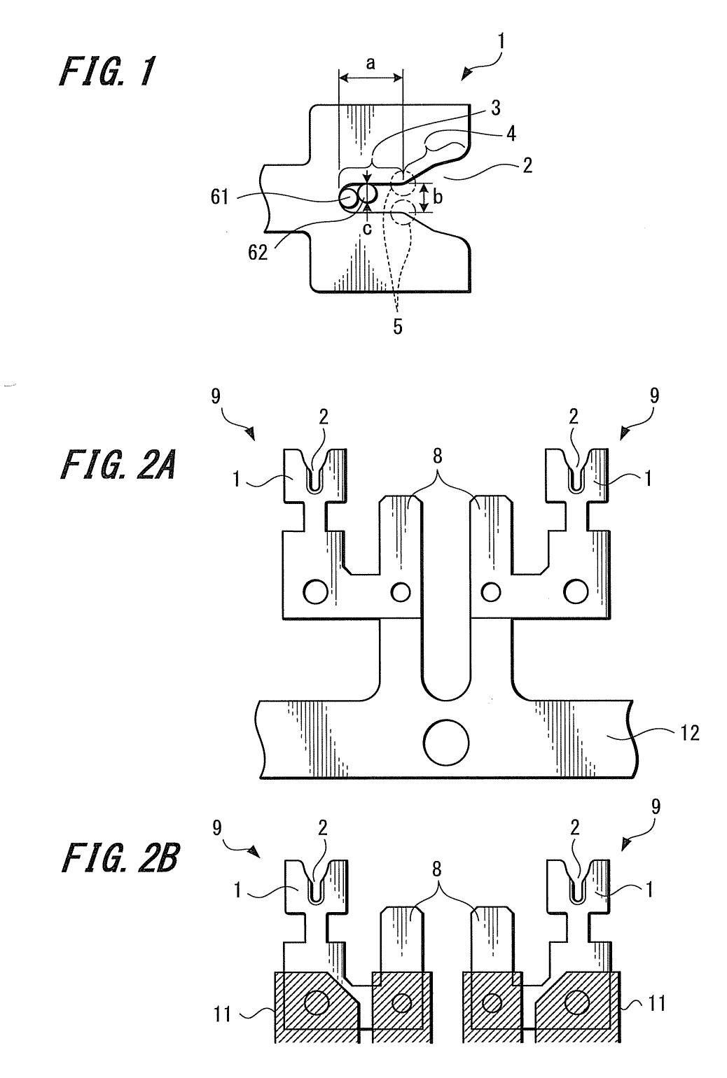

FIG. 1 is an overall configuration of a metal terminal according to an embodiment of the invention. As illustrated in FIG. 1, a metal terminal 1 is formed of a flat metal plate member having an opening portion 2 in a shape of crocodile jaws. The opening portion 2 includes a conductive wire winding portion 3 forming a slit-like opening portion with parallel sides, and a tapered conductive wire introducing portion 4 forming an opening portion which gradually broadens. Two angular portions are formed to face each other at boundaries between the conductive wire winding portion 3 and the conductive wire introducing portion 4; that is, at the opening portion 2 of the conductive wire widning portion 3, thereby forming priority contact portions 5.

The conductive wire winding portion 3 has a function to hold and fix the conductive wire 6 to the metal terminal 1, and the conductive wire introducing portion 4 has a guiding function to facilitate guiding the conductive wire 6 to the conductive wire winding portion 3. Further, the priority contact portions 5 have a function to hold and fix the conductive wire 6 to the metal terminal 1 without applying excessive stress to the conductive wire 6 when the metal terminal 1 is compression processed in the subsequent step.

The metal terminal 1 is formed by punching a phosphor bronze plate having a thickness of approximately 0.65 mm. In addition, Sn plating controlled to have a thickness of 4 μm is pre-applied to the phosphorus bronze plate, and thereby corrosion resistance, soldering property, and welding property are improved of the metal terminal 1.

As shown in FIG. 1, in the metal terminal 1 according to the embodiment of the invention, “a” is defined as a length in the lengthwise direction of the opening portion of the conductive wire winding portion 3, and “b” is defined as a width in the widthwise direction of the opening portion of the conductive wire winding portion 3. Further, “c” is defined as a diameter of the conductive wire 6 to be wound around the conductive wire winding portion 3. Furthermore, the conductive wire winding portion 3 is formed such that the length “a” in the lengthwise direction is 0.65 mm, and the width “b” in the widthwise direction is 0.3 mm.

In the metal terminal 1 of the embodiment, the relationship between the length “a” in the lengthwise direction, the width “b” in the widthwise direction of the conductive wire winding portion 3 and the diameter “c” of the conductive wire 6 wound around the conductive wire winding portion 3 satisfies 3c≦a≦5 and c<b <2c.

Description is made below with respect to the reason for setting the relationship between the length “a” in the lengthwise direction, the width “b” in the widthwise direction of the conductive wire winding portion 3 and the diameter “c” of the conductive wire 6 wound around the conductive wire winding portion 3 so as to satisfy 3c≦a≦5, and c<b<2c. Note that the first wind portion and second wind portion of the conductive wire 6 wound around the conductive wire winding portion 3 are respectively denoted as a conductive wire 61 and a conductive wire 62 for convenience in description.

First, the reason for setting the relationship between b and c to satisfy c<b<2c is described. First, the reason for setting the relationship to satisfy c<b is to enable smooth insertion of the conductive wires 61, 62 into the opening portion of the conductive wire winding portion 3 when performing the winding operation.

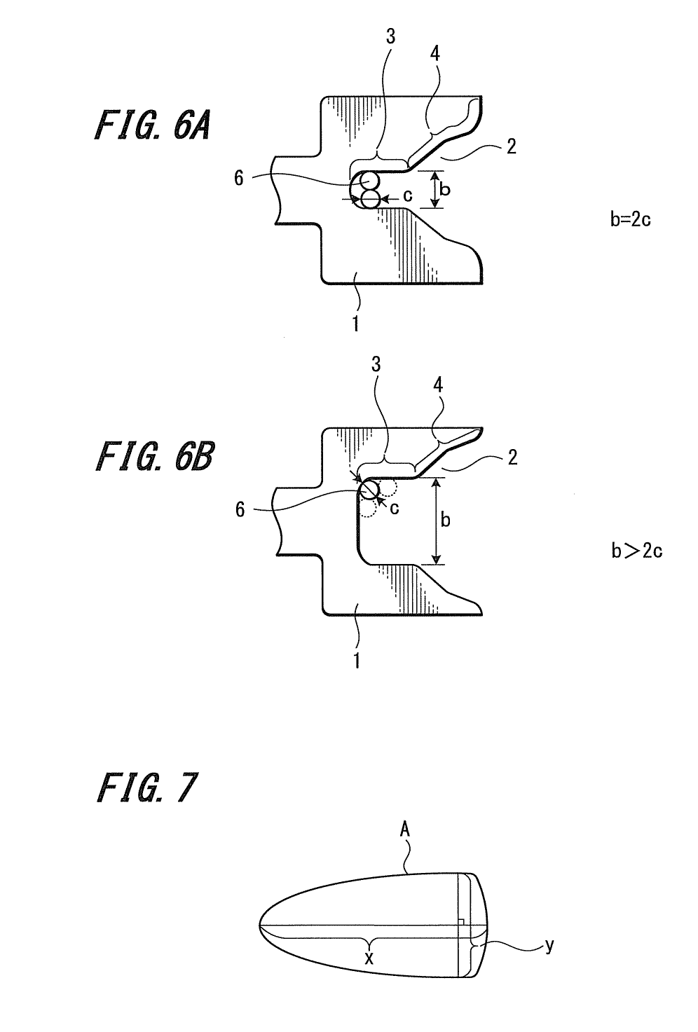

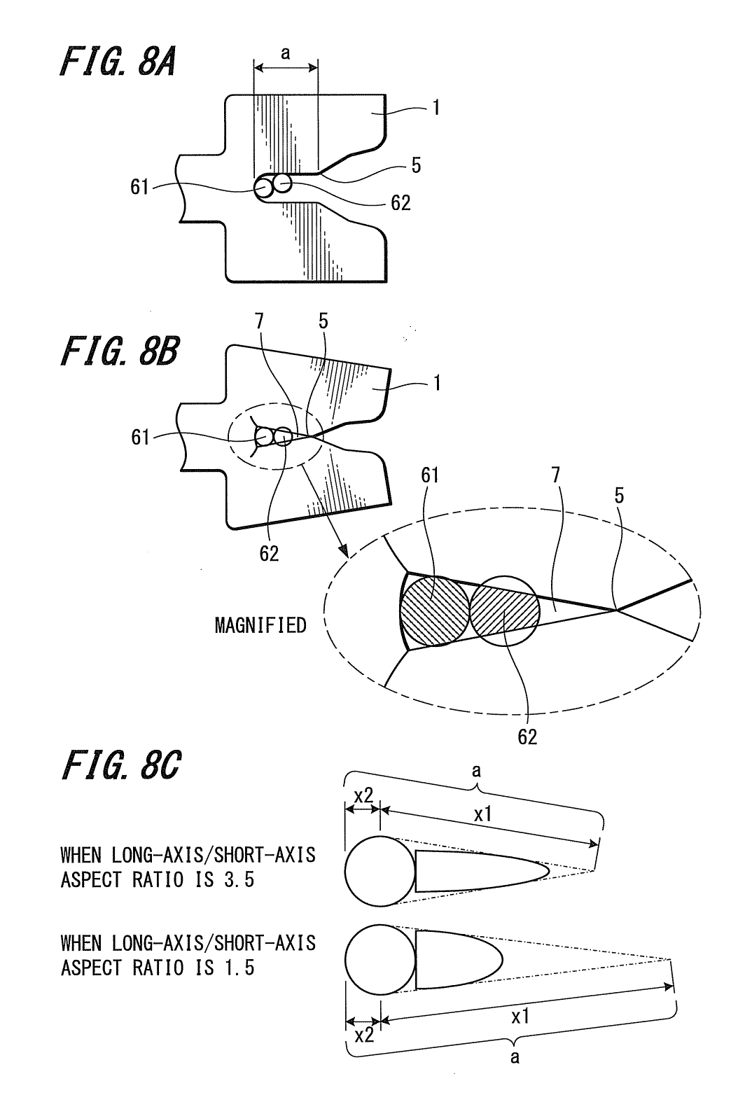

Next, the reason for setting the relationship between b and c to satisfy b<2c is described with reference to FIGS. 6A and 6B. As illustrated in FIG. 6A, if b=2c, in the state that the step of winding the conductive wire 6 has been completed, the first and second wires 61, 62 may have been aligned in the widthwise direction of the opening of the conductive wire winding portion 3. If the conductive wire 6 is wound around the conductive wire winding portion 3 in this manner, when the metal terminal 1 is compressed until the priority contact portions 5 contact each other in the subsequent compressing step, excessive compression stress is applied to the first and second conductive wires 61, 62, disconnection may be caused in the conductive wire 6. Further, if the distance between the priority contact portions 5 formed at boundaries between the conductive wire winding portion 3 and the conductive wire introducing portion 4 increases, the compression processing time until the priority contact portions 5 contact each other increases. Further, the degree of deformation in the opening portion 2 increases, and the metal terminal 1 may be broken.

As illustrated in FIG. 6B, if b>2c, in the state that the step of winding the conductive wire 6 has been completed, the conductive wires 61, 62 may be wound around the conductive wire winding portion 3 with a large gap formed in the widthwise direction of the opening portion. In this state, even if the opening portion 2 is compression processed in the subsequent compression step, it may be difficult to reliably hold and fix the conductive wires 61, 62 to the conductive wire winding portion 3. Further, the compression time until the priority contact portions 5 contact each other increases and the degree of deformation in the opening portion 2 increases, so that the metal terminal 1 may be broken.

For the reasons described above, in the metal terminal 1 of the embodiment, the relationship between the width “b” in the widthwise direction of the opening of the conductive wire winding portion 3 and the diameter “c” of the conductive wire 6 to be wound around the conductive wire winding portion 3 is set to satisfy c <b<2c.

Preferably, when b approximately equals to 1.5c, it is possible to increase degree of freedom in winding the conductive wire 6 around the conductive wire winding portion 3 when completing the step of winding the conductive wire. Further, the dimensional accuracy when the metal terminal 1 is produced by punching a phosphor bronze plate member can be made satisfactory.

Next, the reason why the relationship between the length “a” in the lengthwise direction of the opening of the conductive wire winding portion and the diameter “c” of the conductive wire is set to satisfy 3c≦a≦4.5c will be described.

First, an experiment was carried out to examine and see to what extent the flattening level of the conductive wire 6 must be maintained in order to secure the reliability of the metal terminal 1.

Here, the flatness of the conductive wire 6 will be described below, using a long/short axis aspect ratio. As illustrated in FIG. 7, the long/short axis aspect ratio in this embodiment is defined as a value obtained by dividing a long axis dimension by a short axis dimension in an object A having a long axis x and a short axis y orthogonal to the long axis x. For example, the long/short axis aspect ratio of an object having a round shape or equilateral quadrilateral shape is one, and the long/short axis aspect ratio of an object with the long axis x of two and the short axis y of 0.5 is four.

In the experiment, how the changes in the long/short axis aspect ratio of the conductive wire 6 had affected blowout of the conductive wire 6 occurred in the welding step was examined. Table 1 shows the results of the experiment. Table 1 shows blowout rates (%) that were obtained by dividing the number of samples actually blown out by a parameter (n=50). For example, in a case where the number of samples actually blown out is five, five is divided by 50 to result in a blowout rate of 10%. Note that in this experiment, the conductive wires each having a blowout rate of 5% or less were determined as being in the satisfactory condition in view of the defective product rate in production.

In this experiment, using the conductive wire having a diameter of approximately 0.17 mm before being flattened, samples were prepared so as to meet the conditions of a long/short axis rate of 1, 1.5, 2, 2.5, 3, 3.5, or 4. Next, in a state that each sample of the conductive wire has been stretched in both directions without slack, and heated at about 500° C. for approximately 40 msec, the rates of blowout of the conductive wire were then determined. Note that the heating temperature employed was 500° C. in this experiment, because it is assumed to be a typical temperature applied to conductive wires in the welding step.

TABLE 1

| | Long/short axis aspect ratio | | | | | | |
|---|---|---|---|---|---|---|---|
| | 1 | 1.5 | 2 | 2.5 | 3 | 3.5 | 4 |
| Blowout rates (%) | 1 | 0 | 1 | 2 | 2 | 4 | 6 |
| n = 50 | | | | | | | |

As shown from the result in Table 1, when the conductive wires having blowout rates of 5% or less are defined as “satisfactory” as mentioned above, the long/short axis aspect ratio of the conductive wires that can secure reliability against blowout is in a range of 1 to 3.5.

Note that, as shown in FIGS. 8A and 8B in the metal terminal of this embodiment, the initially wound conductive wire 61 is flattened less, and the secondary wound conductive wire 62 receives greater compression stress, so that the conductive wire 61 is flattened more than the second conductive wire 62. Thus, in the embodiment, the long/short axis aspect ratio of the second conductive wire should be in a range of 1 to 3.5. Note that since there will be substantially no possibility of keeping a state of the long/short axis aspect ratio of the conductive wire 62 is one, the long/short axis aspect ratio of the conductive wire 62 should be set so as to be in a range of 1.5 to 3.5. Moreover, if the conductive wire 6 is wound around the metal terminal 1 three or more times, the long/short axis aspect ratio of the conductive wire 62 wound outermost should be set so as to be in the range of 1.5 to 3.5.

When the compression processing is performed, in a state that conductive wires 61, 62 are wound around the conductive wire winding portion 3 as shown in FIG. 8A, such that the priority contact portions 5 contact each other as shown in FIG. 8B, in the conductive wire winding portion 3, the movements of the conductive wires 61, 62 are regulated such that the conductive wires 61, 62 are regularly aligned, and thereby stress acts in the direction of pushing the conductive wire 62 to the conductive wire 61 side (inside). Simultaneously, the outermost conductive wire 62 is deformed in a compressed manner by receiving compression stress, as shown in an enlarged view of FIG. 8B. At this time, in the conductive wire winding portion 3, the priority portions 5 come in contact with each other first, so that a gap 7 is formed between the conductive wire 62 and the priority contact portions 5.

The deformed state of the conductive wire 62 is analogous to a shape of a bullet or a drop as illustrated in FIG. 8C. As shown in FIG. 8C, the length “a” in the lengthwise direction of the opening of the conductive wire winding portion 3 approximates a distance obtained by adding x1 and x2, where “x1” is defined as a distance between the contact points of the tangential lines connecting the conductive wires 61, 62 and an intersecting point of the two tangential lines, and “x2” is defined as a diameter of conductive wire 61.

Thus, in a case where when the long/short axis aspect ratio of the conductive wire 62 is 1.5, the length “a” in the lengthwise direction of the opening of the conductive wire winding portion 3 approximates 0.60 mm, which is obtained by adding 0.52 mm and 0.085 mm. If the tolerance of ±0.1 mm that is presently conceivable is included, the length “a” in the lengthwise direction of the opening of the conductive wire winding portion 3 should be set in a range of 0.5 mm to 0.7 mm.

Moreover, in a case where the long/short axis aspect ratio of the second wind 62 is 3.5, the length “a” in the lengthwise direction of the opening of the conductive wire winding portion 3 approximates 0.80 mm, which is obtained by adding 0.70 mm and 0.085 mm. If the tolerance of ±0.1 mm that is presently conceivable is considered, the length “a” in the lengthwise direction of the opening of the conductive wire winding portion 3 will be in a range of 0.7 mm to 0.9 mm. Consequently, the length “a” of the conductive wire winding portion 3 should be set in a range of 0.5 mm to 0.9 mm.

Here, comprehensively considering the cases where the long/short axis aspect ratios of the conductive wire 62 are 1.5 and 3.5, if the broadest range of dimensions is examined, the range of the length “a” in the lengthwise direction of the opening of the conductive wire winding portion 3 will be in a range of 0.5 mm to 0.9 mm. Consequently, when the length “a” is computed based on the ratio of the length in the lengthwise direction of the opening of the conductive wire winding portion 3 with the diameter of the conductive wire 6 of approximately 0.17 mm obtained before being flattened, the range of the length “c” is approximately 3c≦a≦5c.

For the reasons described above, in the metal terminal 1 of the embodiment, the relationship between the length “a” in the lengthwise direction of the opening of the conductive wire winding portion 3 and the diameter “c” of the conductive wire 6 to be wound around the conductive wire winding portion 3 is defined so as to satisfy 3c≦a≦5c. Thus, in the metal terminal 1 of the embodiment, the relationship between the length “a” in the lengthwise direction and the width “b” in the widthwise direction of the opening of the conductive wire winding portion 3 and the diameter “c” of the conductive wire 6 to be wound around the conductive wire winding portion 3 is prescribed so as to satisfy 3c≦a≦5c and c<b<2c.

Note that in the step of welding the conductive wire 6 and the metal terminal 1, the smaller the degree of flatness of the conductive wire 62 (the smaller the long/short aspect ratio is), the more uniformly heat in welding is conducted to the conductive wire, so that blowout of the conductive wire will be hard to occur. It is preferable to use that the conductive wire 62 having the long/short axis aspect ratio of 1.5. In view of the length “a” in the lengthwise direction of the opening of the conductive wire winding portion being in a range of 0.5 mm to 0.7 mm, the particularly preferable relationship between the length “a” in the lengthwise direction of the specifically preferable conductive wire winding portion 3 and the diameter “c” of the conductive wire 6 to be wound around the conductive wire winding portion 3 is in a range of 3c ≦a≦4.2c.

According to the metal terminal 1 of the embodiment, since the relationship between the length “a” in the lengthwise direction and the width “b” in the widthwise direction of the opening of the conductive wire winding portion 3 and the diameter “c” of the conductive wire 6 wound around the conductive wire winding portion 3 is set to satisfy 3c≦a≦5, and c<b<2c, the conductive wire 6 may not excessively be flattened when holding and fixing the conductive wire 6 to the metal terminal 1 in the subsequent compression step, so that breaking of the conductive wire 6 can be suppressed. In the compression processing step, the movement of the conductive wire 6 wound around the conductive wire winding portion 3 is regulated such that the conductive wires 61, 62 are regularly aligned, so that the fixing positions of the conductive wire 6 around the conductive wire winding portion 3 are uniform, thereby improving the quality of the metal terminal 1.

Further, since the priority contact portions 5 are provided at the boundaries between the conductive wire winding portion 3 and the conductive wire introducing portion 4, in the compression processing step, the step terminates in the state that the priority contact portions 5 are preferentially brought into contact with each other to form the gap 7. Thus, there is no possibility of applying excessive compression stress to the conductive wire 6 even when compression-processing is performed. That is, it is possible to manufacture excellent products by merely managing the compression step and the compression condition such that the priority contact portions 5 are brought into contact with each other.

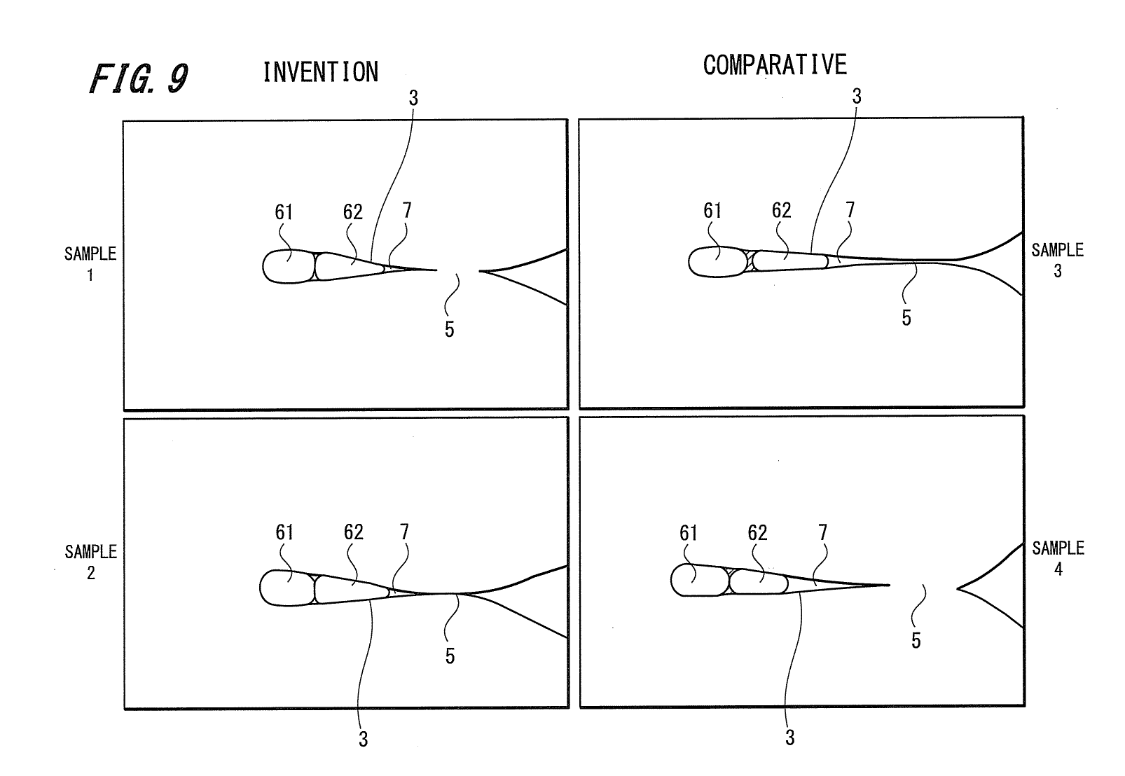

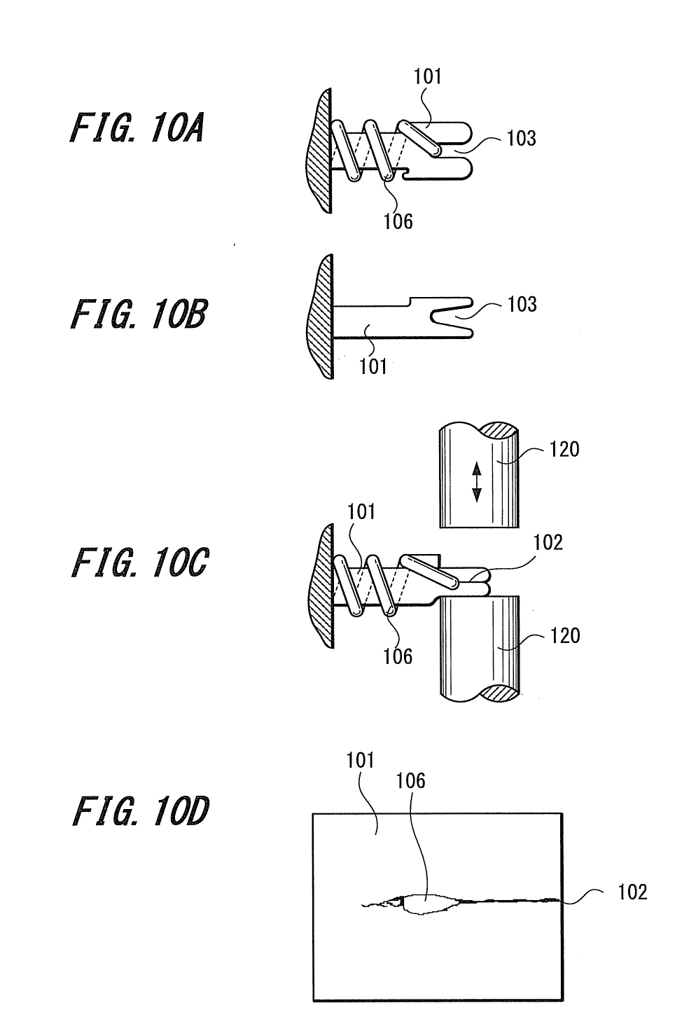

FIG. 9 is a view illustrating comparison between the states of the cross sections of the conductive wires 61, 62 in the metal terminal 1 of the present embodiment and the states of the cross sections of the conductive wires 61, 62 in a metal terminal other than the metal terminal 1 of the present embodiment. Samples 1, 2 indicate the metal terminals of this embodiment, whereas samples 2, 3 indicate those of a comparative embodiment. Samples 1, 2 are manufactured so as to meet the same condition, and Samples 3, 4 are also manufactured so as to meet the same condition.

As clear from FIG. 9, comparing Sample 1 with Sample 2 as the invention, the states of the conductive wires 61, 62 are approximately the same after compression processing. Specifically, the compressed degree and contact areas of the conductive wires 61, 62 are also approximately the same. Further, the sizes of the gaps 7 formed in the conductive wire winding portion 3 are also approximately the same.

In contrast, comparing Sample 3 with Sample 4, the states of the cross sections of the conductive wires 61, 62 after compression processing are clearly different. Specifically, the flattening degree of the conductive wire 62 in Sample 3 is clearly greater than that in Sample 4. In Sample 3, a gap is formed between the conductive wires 61, 62 and the conductive wires 61, 62 do not contact each other; however, in Sample 4, the contact wires 61, 62 are arranged so as to contact each other. Accordingly, the size of the gap 7 formed in the conductive wire winding portion 3 is different between in Sample 1 and Sample 2.

FIG. 2A is a schematic view illustrating an metal terminal component 9 having the metal terminal 1, during production, and illustrates a state immediately after processing a phosphor bronze plate by punching and in which the metal terminal component 9 is connected with a frame 12. Note that the same reference numerals are provided for components in FIG. 2A that are identical to those shown in FIG. 1, and description thereof is thus omitted.

As shown in FIG. 2A, the metal terminal component 9 includes the metal terminal 1 having the opening portion 2 for winding the aforementioned conductive wire 6 around the conductive wire winding portion 3, and an input-output terminal 8. The input-output terminal 8 includes a planer portion formed therein, thus enabling connection of lead terminals/lead pins (not shown) and electrical connection of coil components to external electric circuits/electric devices as well.

Then, as illustrated in FIG. 2B, the metal terminal 1 and the input-output terminal 8 forming the metal terminal component 9 are separated from the frame 12 by cut processing, or the like, both of which are then respectively implanted in a resin base bobbin 11.

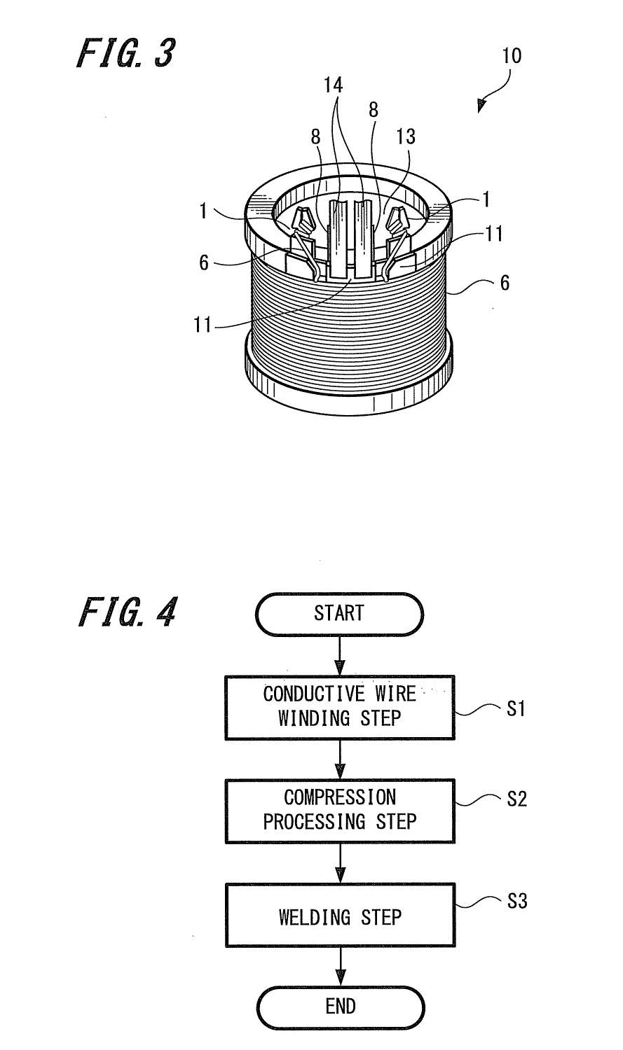

Next, a coil component according to an embodiment of the invention is illustrated with reference to FIG. 3. FIG. 3 is an overall view illustrating a coil component 10 that includes the metal terminal component 9 having the metal terminal 1. Note that the same reference numerals are provided for the components in FIG. 3 which are identical to those shown in FIG. 2A, and description thereof is thus omitted.

As illustrated in FIG. 3, the coil component 10 of the embodiment includes the resin base bobbin 11 having a winding spindle with an air-core portion 13, the conductive wire 6 wound around the winding spindle, the metal terminal 1 implanted in the resin base bobbin 11, and lead pins 14 connected to the input-output terminal 8. An end portion of the conductive wire 6 forming the coil is wound around the conductive wire winding portion 3 of the metal terminal 1 of the metal terminal component 9 and is held and fixed to the metal terminal 1.

According to the coil component 10 of the embodiment, since the relationship between the length “a” in the lengthwise direction, the width “b” in the widthwise direction of the opening of the conductive wire winding portion 3 and the diameter “c” of the conductive wire 6 wound around the conductive wire winding portion 3 is set to satisfy 3c≦a≦5 and c<b<2c, the fixing position of the conductive wire 6 held and fixed to the metal terminal 1 are made uniform, so that even when the coil component 10 is mass-produced, the product quality can be maintained.

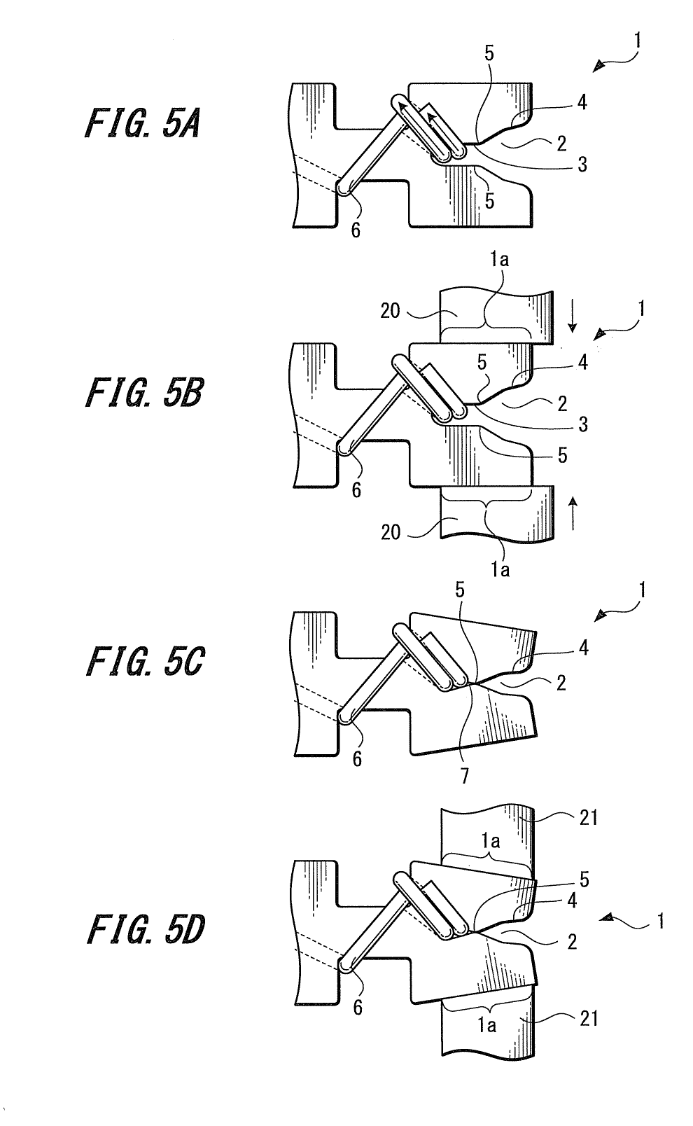

Next, a method for holding and fixing a conductive wire to the metal terminal of the invention is illustrated with reference to FIG. 4 and FIGS. 5A, 5B, 5C, and 5D. FIG. 4 is a flow-chart illustrating a manufacturing step for holding and fixing the conductive wire 6 to the metal terminal 1. FIGS. 5A, 5B, 5C, 5D are views illustrating the states of the metal terminal and the conductive wire deforming according to the flow-chart of the manufacturing steps. Note that the method for holding and fixing a conductive wire to the metal terminal of the invention is not limited to the embodiment described below.

As shown in FIG. 4, when holding and fixing the conductive wire 6 to the metal terminal 1, the steps of winding (step 1), compression-processing (step 2), and welding (step 3) the conductive wire are included.

First, in step S1, as illustrated in FIG. 5A, the conductive wire 6 extending from the wound coil, not shown, is wound a plurality of times (about twice in this example) around the opening portion 2 having a crocodile's jaws-shape the metal terminal 1. In this case, the conductive wire 6 can be wound around the metal terminal 1 without slack while applying tensile force to the conductive wire 6 in the direction indicated by an arrow in FIG. 5A.

Next, in step S2, as illustrated in FIG. 5B, the compression-processing is performed bringing a compression tool 20 into contact with a predetermined area 1a of the metal terminal 1 until the priority contact portions 5 are in contact with each other. The reason of bringing the compression tool 20 into contact with the predetermined area la the metal terminal 1 is that only the opening portion 2 having the crocodile's jaws-shape can be deformed by minimum necessary pressure, while obtaining the cost-efficiency in the mass production environment. Since only the opening portion 2 is deformed and adequate gap 7 can be formed as illustrated in FIG. 5C by bringing into contact with each other first, the conductive wire 6 can be prevented from being excessively flattened. Further, since compressing or application of pressure with the compression tool 20 should terminate when the priority portions 5 are brought into contact with each other without flattening the conductive wire 6 excessively, and the compression step is significantly simplified. Here, as the control of the compression-processing step using a pressure gauge or the like, the compression-processing step can terminate at a point where the priority contact portions 5 have contacted each other and the pressure has increased.

Next, in step S3, as shown in FIG. 5D, after the compression step (step 2) described above, a welding electrode 21 is brought into contact with the predetermined area of the metal terminal 1 so as to weld the conductive wire 6 and the metal terminal 1. As described above, through steps S1 to S3, the step of holding and fixing the conductive wire 6 to the metal terminal 1 is thus completed.

According to the method for holding and fixing a conductive wire to a metal terminal of the embodiment, the adequate gap 7 can be formed in the conductive wire winding portion 3 with synergistic factors of the step of winding the conductive wire around the opening portion 2 having the conductive wire winding portion 3, the conductive wire introducing portion 4, and the priority contact portions 5 while applying tensile force to the conductive wire 6 in a predetermined direction; and the compressing step of bringing the compression tool into contact with to the predetermined area of the metal terminal and applying pressure until the priority contact portions contact each other. Thereby, the conductive wire 6 wound can be prevented from being flattened excessively, thereby decreasing the frequency of breaking the conductive wire 6 wound around the metal terminal 1.

Further, in the process of forming the gap 7, the movement of the conductive wire 6 around the conductive wire winding portion 3 is regulated such that the conductive wires 61, 62 are regularly aligned, the fixing positions of the conductive wire 6 wound around the conductive wire winding portion 3 are made uniform, thereby improving the quality of the product. In addition, since it becomes less that the position of holding and fixing the conductive wire to the metal terminal differs on a product to product basis, an effect of constant heat conductivity can be obtained in a subsequent welding step, and the conductive wire 6 can simply and securely be held and fixed to the metal terminal 1.

Explanation of Reference Numerals

1. metal terminal;

2. opening portion;

3. conductive wire winding portion;

4. conductive wire introducing portion;

5. priority contact portion;

6. conductive wire;

7. gap;

8. input terminal

9. metal terminal component;

10. coil component;

11. resin-based bobbin;

12. frame;

13. air-core portion;

14. lead pin;

20. compression tool;

21. welding electrode;

a. length in lengthwise direction of conductive wire winding portion;

b. width in widthwise direction of conductive wire winding portion;

c. diameter of conductive wire

1. A metal terminal comprising:
an opening portion having a conductive wire winding portion; and a conductive wire introducing portion, characterized in that when “a” is defined as a length in the lengthwise direction of the opening of the conductive wire winding portion, “b” is defined as a width in the widthwise direction of the opening of the conductive wire winding portion, and “c” is defined as a diameter of the conductive wire wound around the conductive wire winding portion, 3c≦a≦5c and c<b<2c are satisfied.

2. The metal terminal according to claim 1, characterized in that the conductive wire is wound at least twice around the conductive wire winding portion.

3. The metal terminal according to claim 2, characterized in that a long/short axis aspect ratio of the conductive wire wound outermost around the conductive wire winding portion is in a range of 1.5 to 3.5 when the opening portion is deformed by compression.

4. The metal terminal according to claims 1 to 3, characterized in that priority contact portions, which are preferentially brought into contact with each other when the opening portion is deformed by compression, are formed at a boundary between the conductive wire winding portion and the conductive wire introducing portion.

5. A coil component, comprising:
a bobbin;
a conductive wire wound around the bobbin; and
a metal terminal holding and fixing an end portion of the conductive wire, characterized in that the metal terminal includes an opening portion having a conductive wire winding portion and a conductive wire introducing portion, and when “a” is defined as a length in the lengthwise direction of the opening of the conductive wire winding portion, “b” is defined as a width in the widthwise direction of the opening of the conductive wire winding portion, and “c” is defined as a diameter of the conductive wire wound around the conductive wire winding portion, 3c≦a≦5c and c<b<2c are satisfied.

6. The coil component according to claim 5, characterized in that the conductive wire is wound at least twice around the conductive wire winding portion.

7. The coil component according to claim 6, characterized in that a long/short axis aspect ratio the conductive wire wound outmost around the conductive wire winding portion is in a range of 1.5 to 3.5 when the opening portion of the conductive wire winding portion is deformed by compression.

8. The coil component according to claims 5 to 7, characterized in that priority contact portions, which are preferentially brought into contact with each other when the opening portion is deformed by compression, are each formed at a boundary between the conductive wire winding portion and the conductive wire introducing portion.

9. A method for holding and fixing an end portion of a conductive wire to a metal terminal including an opening portion having a conductive wire winding portion and a conductive wire introducing portion, comprising the steps of:
winding the end portion of the conductive wire a plurality of times around the conductive wire winding portion;
bringing a compression tool into contact with the metal terminal and compressing the metal terminal until the opening portion of the conductive wire winding portion is closed; and
bringing a welding electrode into contact the mental terminal and welding the conductive wire and the metal terminal.

10. The method for holding and fixing a conductive wire to a metal terminal according to claim 9, characterized in that priority contact portions formed at a boundary between the conductive wire winding portion and the conductive wire introducing portion are preferentially brought into contact with each other when in the compression step, deforming the opening portion.

11. The method for holding and fixing a conductive wire to a metal terminal according to claim 9 or 10, characterized in that in the compressing step, deformation of the opening portion terminates when the priority contact portions have come in contact with each other.
